(19) United States
(12) Patent Application Publication
(10) Pub. No.: US 2023/0092340 A1
(43) Pub. Date: Mar. 23, 2023

(54) Pet Paw Slip Inhibiting Device

(71) Applicant: Dillon Harris, Sioux Falls, SD (US)

(72) Inventor: Dillon Harris, Sioux Falls, SD (US)

(21) Appl. No.: 17/479,676

(22) Filed: Sep. 20, 2021

(51) Int. Cl. A01K 29/00; B60J 5/04

(52) U.S. Cl. CPC A01K 29/00; B60J 5/0493

(57) ABSTRACT

A pet paw slip inhibiting device inhibits slippage of a pet's paw adjacent to an open vehicle window. The device includes a pad. The pad is elongated and constructed of a flexible material. A back surface of the pad is positions in abutment with a surface of a vehicle adjacent to a window. A front surface of the pad is compressed by a paw of a pet forming a depression conforming to and receiving the paw to inhibit slipping on the front surface. An attachment is coupled to the pad for engagement to the surface of the vehicle in a fixed position relative to the window.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to slip inhibiting devices and more particularly pertains to a new slip inhibiting device for inhibiting slippage of a pet's paw adjacent to an open vehicle window.

### (2) Description of Related Art Including Information Disclosed Under 37 CFR 1.97 and 1.98

The prior art relates to slip inhibiting devices designed to enhance grip or prevent slippage on a surface.

### BRIEF SUMMARY OF THE INVENTION

An embodiment of the disclosure meets the needs presented above by generally comprising a pad. The pad is elongated and constructed of a flexible material. A back surface of the pad is positions in abutment with a surface of a vehicle adjacent to a window. A front surface of the pad is compressed by a paw of a pet forming a depression conforming to and receiving the paw to inhibit slipping on the front surface. An attachment is coupled to the pad for engagement to the surface of the vehicle in a fixed position relative to the window.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded top front side perspective view of a pet paw slip inhibiting device according to an embodiment of the disclosure.

FIG. 2 is a top rear side perspective view of an embodiment of the disclosure.

FIG. 3 is a front view of an embodiment of the disclosure.

FIG. 4 is a cross-sectional view of an embodiment of the disclosure taken along line 4-4 of FIG. 3.

FIG. 5 is a front view of an embodiment of the disclosure.

FIG. 6 is a cross-sectional view of an embodiment of the disclosure taken along line 6-6 of FIG. 5.

FIG. 7 is a top front side perspective exploded view of an embodiment of the disclosure in a vehicle.

FIG. 8 is a top front side perspective view of an embodiment of the disclosure in use.

### DETAILED DESCRIPTION OF THE INVENTION

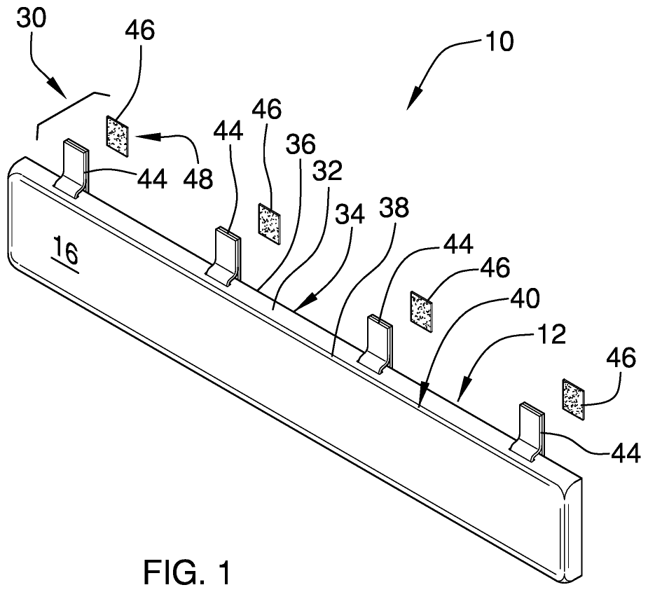

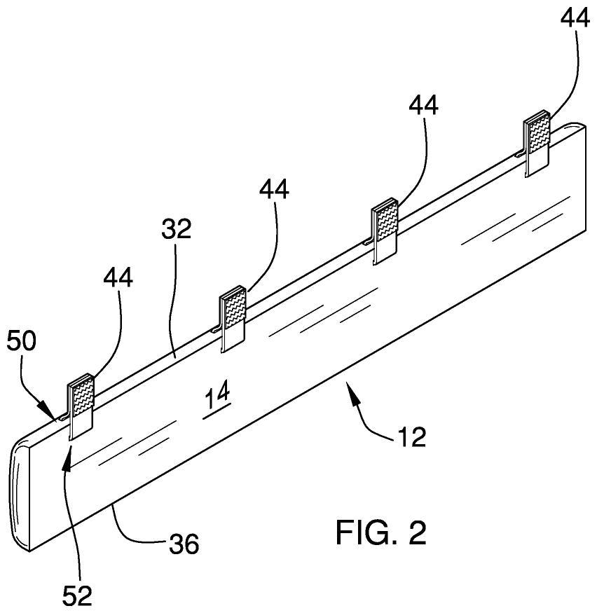

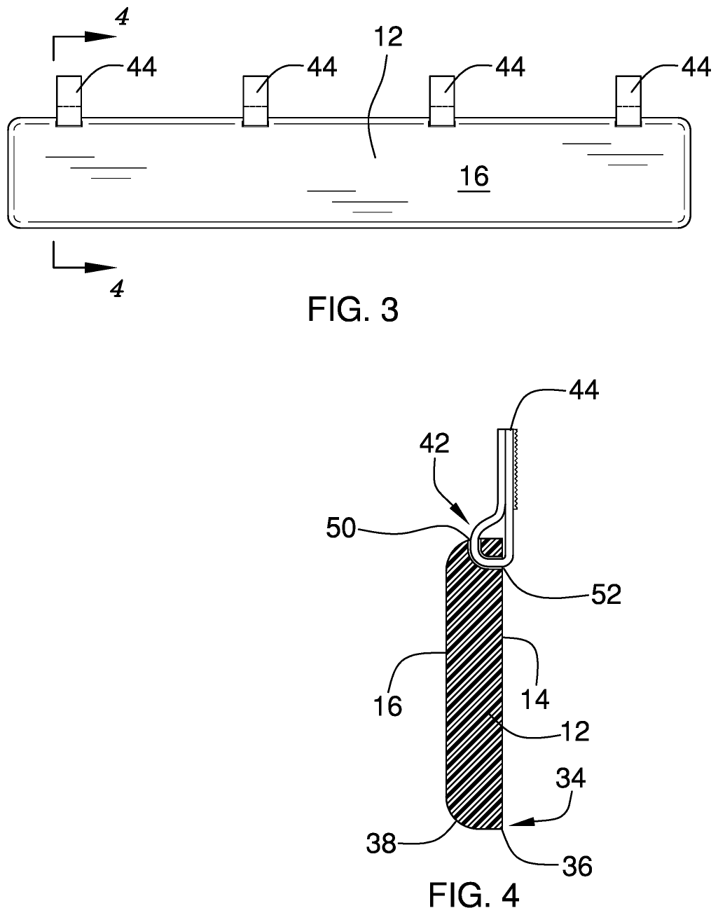

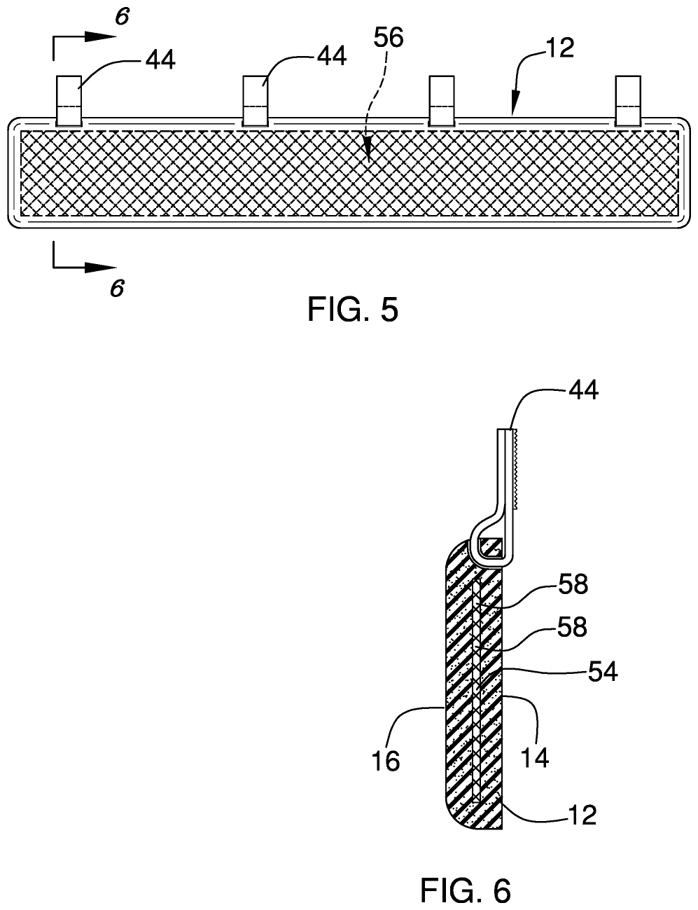

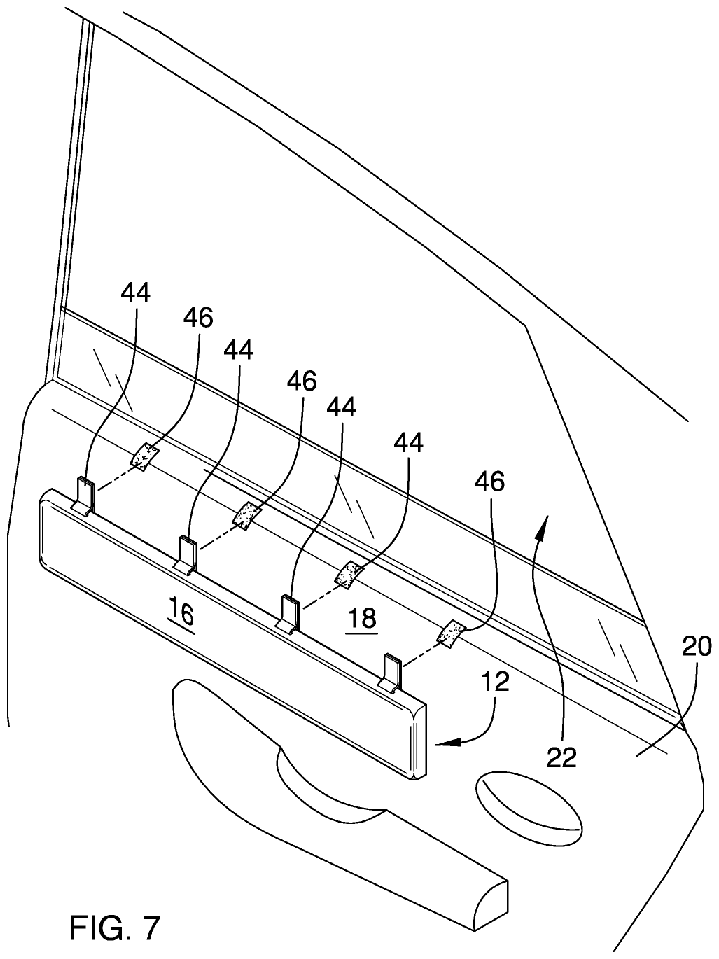

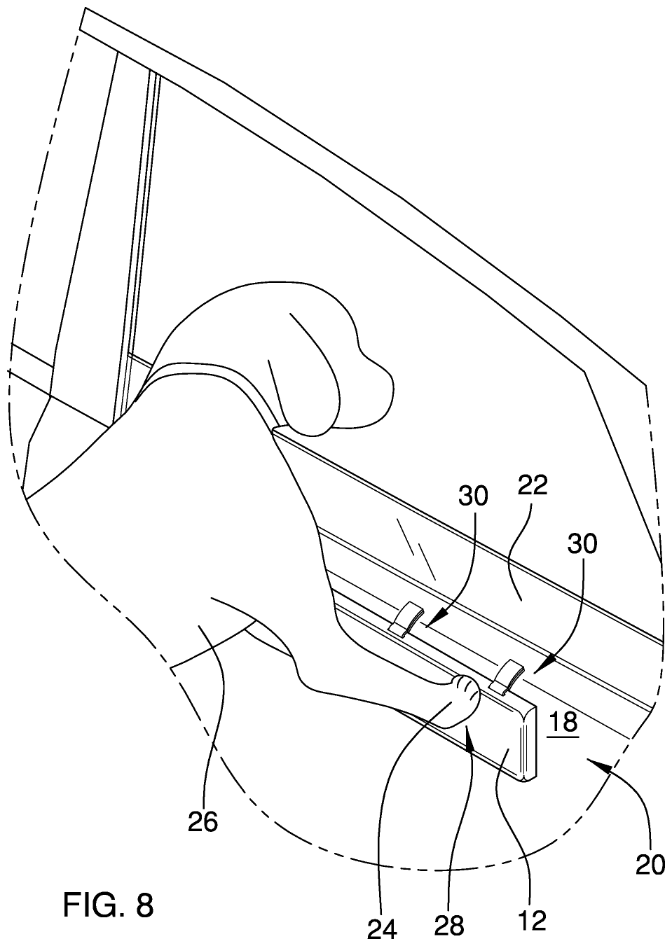

With reference now to the drawings, and in particular to FIGS. 1 through 8 thereof, a new slip inhibiting device embodying the principles and concepts of an embodiment of the disclosure and generally designated by the reference numeral 10 will be described.

As best illustrated in FIGS. 1 through 8, the pet paw slip inhibiting device 10 generally comprises a pad 12. The pad 12 is elongated and constructed of a flexible material such as silicone gel, or the like. The pad 12 has a back surface 14 and a front surface 16. The back surface 14 is configured for positioning in abutment with a surface 18 of a vehicle 20 adjacent to a window 22 of the vehicle 20. Thus, the front surface 16 is exposed on the surface 18 of the vehicle 20 adjacent to the window 22. The front surface 16 is compressible such that the pad 12 is configured for being compressed by a paw 24 of a pet 26 such that the pad 12 forms a depression 28 conforming to and receiving the paw 24 of the pet 26. Thus, the pad 12 inhibits the paw 24 of the pet 26 from slipping on the front surface 16. An attachment 30 is coupled to the pad 12. The attachment 30 is configured for engagement to the surface 18 of the vehicle 20 whereby the pad 12 is secured in a fixed position relative to the window 22.

The pad 12 has a peripheral surface 32 extending fully around the pad 12 between the back surface 14 and the front surface 16. A junction 34 between the back surface 14 and the peripheral surface 32 defines a sharp edge 36 extending fully around the back surface 14. A transition 38 between the front surface 16 and the peripheral wall 32 is curved defining a smooth arcuate edge 40 extending around the front surface 16.

Each of a plurality of slots 42 extends through the pad 12. The attachment 30 comprises a plurality of hook and loop straps 44. Each hook and loop strap 44 extends through a respective one of the slots 42 whereby each of the hook and loop straps 44 is coupled to the pad 12. A hook and loop tab 46 is complementary to the hook and loop straps 44 whereby the hook and loop straps 44 are removably couplable to the hook and loop tab 46. The hook and loop tab 46 has an adhesive surface 48 wherein the hook and loop tab 46 is configured for adhering to the surface 18 of the vehicle 20. The hook and loop tab 46 may be a single piece or one of a plurality of hook and loop tabs 46 with each hook and loop strap 44 being couplable to a respective one of the hook and loop tabs 46. Each slot 42 has a first end 50 positioned on the peripheral surface 32 and a second end 52 positioned on the back surface 14. Thus, each slot 42 is substantially L-shaped within the pad 12.

In an embodiment, a panel 54 is positioned within the pad 12. The panel 54 is bendable wherein the panel 54 is configured to facilitate shaping of the panel 54 to conform to a shape of the surface 18 of the vehicle 20 adjacent to the window 22. The panel 54 comprises a grating 56 wherein material of the pad 12 extends through and around openings 58 through the panel 54.

In use, the pad 12 is installed in the vehicle 20 on the surface 18 adjacent to the window 22. The pet 26 may then place one or more paws 24 on the pad 12 wherein the pad 12 inhibits the paw 26 from slipping on the surface 18 to enhance safety of the pet 26 when positioned adjacent to the window 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet paw slip inhibiting device comprising:
a pad, said pad being elongated, said pad being constructed of a flexible material, said pad having a back surface and a front surface, said back surface being configured for positioning in abutment with a surface of a vehicle adjacent to a window of the vehicle whereby said front surface is exposed on a vehicle surface adjacent to the window of the vehicle, said front surface being compressible such that said pad is configured for being compressed by a paw of a pet such that said pad forms a depression conforming to and receiving the paw of the pet whereby said pad inhibits the paw of the pet from slipping on the front surface; and
an attachment coupled to said pad, said attachment being configured for engagement to the surface of the vehicle whereby said pad is secured in a fixed position relative to the window.

2. The device of claim 1, further comprising said pad being constructed of silicone gel.

3. The device of claim 1, further comprising said pad having a peripheral surface extending fully around said pad between said back surface and said front surface.

4. The device of claim 3, further comprising a junction between said back surface and said peripheral surface defining a sharp edge extending fully around said back surface.

5. The device of claim 3, further comprising a transition between said front surface and said peripheral wall being curved defining a smooth arcuate edge extending around said front surface.

6. The device of claim 1, further comprising:
a plurality of slots extending through said pad; and
said attachment comprising
a plurality of hook and loop straps, each hook and loop strap extending through a respective one of said slots whereby each of said hook and loop straps is coupled to said pad, and
a hook and loop tab, said hook and loop tab being complementary to said hook and loop straps whereby said hook and loop straps are removably couplable to said hook and loop tab, said hook and loop tab having an adhesive surface wherein said hook and loop tab is configured for adhering to the vehicle surface.

7. The device of claim 6, further comprising said hook and loop tab being one of a plurality of hook and loop tabs, each hook and loop strap being couplable to a respective one of said hook and loop tabs.

8. The device of claim 6, further comprising each slot having a first end positioned on said peripheral surface and a second end positioned on said back surface.

9. The device of claim 8, further comprising each slot being substantially L-shaped within said pad.

10. The device of claim 1, further comprising a panel positioned within said pad, said panel being bendable wherein said panel is configured to facilitate shaping of said panel to conform to a shape of the vehicle surface adjacent to the window.

11. The device of claim 10, wherein said panel comprises a grating wherein material of said pad extends through and around openings through said panel.
